(19) United States
(12) Patent Application Publication
(10) Pub. No.: US 2009/0211253 A1
(43) Pub. Date: Aug. 27, 2009

(54) Organic Rankine Cycle Mechanically and Thermally Coupled to an Engine Driving a Common Load

(75) Inventors: Thomas D. Radcliff, Vernon, CT (US); Bruce P. Biederman, West Hartford, CT (US); Kent R. McCord, Granby, CT (US); Lili Zhang, East Hartford, CT (US)

Correspondence Address: M P Williams, 210 Main Street, Manchester, CT, 06042, US

(73) Assignee: UTC POWER CORPORATION, South Windsor, CT (US)

(21) Appl. No.: 11/922,298

(22) PCT Filed: Jun. 16, 2006
(86) PCT No.: PCT/US2006/023301

§ 371 Date: Dec. 14, 2007

Related U.S. Application Data
(60) Provisional application No. 60/691,067, filed on Jun. 16, 2005.

(51) Int. Cl. F01K 23/06; F02G 5/04

(52) U.S. Cl. 60/670; 123/2

(57) ABSTRACT

The shaft (20) of an engine (19) is coupled to a turbine (28) of an organic Rankine cycle subsystem which extracts heat (45-48, 25) from engine intake air, coolant, oil, EGR and exhaust. Bypass valves (92,94, 96, 99) control engine temperatures. Turbine pressure drop is controlled via a bypass valve (82) or a mass flow control valve (113). A refrigeration subsystem having a compressor (107) coupled to the engine shaft uses its evaporator (45a) to cool engine intake air. The ORC evaporator (25a) may comprise a muffler including pressure pulse reducing fins (121, 122), some of which have NOx and/or particulate reducing catalysts thereon.

The benefit of U.S. provisional application No. 60/691,067 filed Jun. 16, 2005 is claimed.

### TECHNICAL FIELD

This invention relates to an organic Rankine cycle (ORC) system in which the turbine mechanical output is coupled to a common load with an engine mechanical energy output, the ORC utilizing the engine's waste thermal energy to evaporate the ORC fluid as it cools the engine. An electric generator or other load may be driven by the combined engine/ORC system of the invention.

### BACKGROUND ART

Efficient power generation systems that provide low-cost energy with minimum environmental impact, and that can be readily and rapidly sited as stand-alone units for integration into the existing power grid, are appropriate for solving critical power needs in many areas. Reciprocating engines are the most common and most technically mature of these distributed energy resources, but turbines may also be used. These engines can generate electricity with efficiencies of 25% to 40% using commonly available fuels such as gasoline, natural gas and diesel fuel. However, atmospheric emissions such as nitrogen oxides, (NOx), carbon monoxide (CO) and particulates have always been an issue with these engines.

The efficiency of combustion engines can be improved without increasing the output of emissions by means of a bottoming cycle. One form of bottoming cycle is an organic (with fluid alternating phases) Rankine cycle system which is thermally coupled to a reciprocating engine and operates an electric generator.

Current practice provides separate loads driven by separate shafts for engines which integrate, via exhaust heat, with organic Rankine cycle devices, as illustrated in FIG. 1. Therein, an engine 19 powers a shaft 20 that drives a main generator 21. The exhaust 24 of the engine passes through an evaporator 25 which evaporates the ORC fluid from a conduit 26. The vaporized fluid in a conduit 27 drives a turbine 28, which has a shaft 31 that drives an auxiliary generator 32. The turbine outflow in a conduit 34 is condensed in a condenser 35 which is cooled by a flow of ambient air 36 created by a fan 37. The condensed fluid in a conduit 40 is driven by a pump 41 through the conduit 26 to the evaporator 25.

The electrical output of the generators 21, 32 is applied to power combining and conditioning circuitry 43 so as to drive a common load 44, which may or may not be a power utility grid.

This approach requires separate, redundant generators, control equipment and power conversion components; the power combining circuitry is an additional burden to such a system.

The system described with respect to FIG. 1 utilizes a small percentage of the waste engine heat, and does not deal with the heat elimination requirements of the engine. Therefore, maximal efficiency cannot even be approached with such a system.

### DISCLOSURE OF INVENTION

Aspects of the invention include: utilizing substantially all the heat that must be eliminated from an engine driving a load in an associated ORC system which is thermally and mechanically coupled with the engine; utilizing an ORC system to eliminate substantially all of the heat which must be extracted from an engine driving a load; operating a single mechanical load directly with mechanical power provided by an engine and an ORC system which is mechanically and thermally coupled thereto; providing an engine sharing a mechanical load with an ORC system, without the need for redundant replicated equipment; driving a single generator with an engine and ORC system mechanically coupled thereto without the need for complicated load. sharing, power combining apparatus.

In accordance with the invention, the shaft of an engine is mechanically coupled with a shaft of a turbine of an organic Rankine cycle system, substantially all of engine waste heat being utilized to evaporate the organic Rankine cycle fluid, thereby maximizing the efficiency of the combined system. In further accord with the invention, condensed organic Rankine cycle fluid flows through various engine-related coolers, including one or more of: intake air (charge air) cooler; engine coolant; engine oil cooler; EGR cooler; as well as using engine exhaust in the evaporator.

According to the invention, coupling between the ORC turbine and the engine crank may be a shared shaft, or it could include coupling devices to limit application of torque, such as clutches; the coupling could include devices to directionally limit torque, such as sprag clutches or free-wheeling clutches. The coupling may also include speed modifying couplings such as gear sets, belt drives, fluid torque converters, or variable speed transmissions.

The utilization of the liquid-to-liquid heat exchangers 46-48 replaces large liquid-to-air heat exchangers and their associated fans, with considerable reduction in cost, and/or an in-coolant engine oil cooler.

Other features of the invention include: evaporator bypass (ORC fluid or exhaust) to maintain ORC vapor temperature, passively or in response to a controller; bypassing ORC fluid or engine fluid around heat exchangers to maintain engine fluid temperatures; combined heat exchangers; engine oil pump pressurizing turbine oil; ORC fluid in coolant passages within engine; refrigerating intake air, with coolant condenser heating ORC fluid; bypassing ORC turbine during turbine failure, with extra condenser cooling and/or evaporator bypass, or to control turbine pressure drop; controlling turbine pressure with mass flow, variable speed transmission; and adopting the evaporator to be a muffler and/or an emissions reducing device.

Other aspects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified, stylized block diagram of a reciprocating engine employing an organic Rankine bottoming cycle (ORC) which drives an auxiliary generator.

FIG. 2 is a simplified, stylized block diagram of a reciprocating engine combined with an ORC bottoming cycle driving a single generator in accordance with the invention.

FIG. 3 is a simplified, stylized illustration of an embodiment of the invention employing a variety of novel features.

FIG. 4 is a fragmentary illustration of an engine coupled to the turbine of an associated ORC subsystem through a free wheeling clutch.

FIG. 5 illustrates a solenoid actuator clutch.

FIG. 6 illustrates a variable speed transmission.

FIG. 7 illustrates a fluid coupling.

FIG. 7a illustrates gears.

FIG. 8 is a fragmentary, simplified, stylized illustration of regulation of mass flow to control turbine pressure ratio.

FIG. 9 is a fragmentary illustration of a combined engine coolant, engine oil and ORC working fluid heat exchanger.

FIG. 10 is an illustration of a combined oil, EGR air, and ORC working fluid heat exchanger.

FIG. 11 is a fragmentary, simplified stylized illustration of controlling engine temperature by means of bypass valves.

FIG. 12 is a simplified, stylized illustration of an engine employing an ORC subsystem in which the ORC working fluid comprises the engine coolant.

FIG. 13 is a fragmentary illustration of bypassing the ORC working fluid around the evaporator to assure adequate engine cooling.

FIG. 14 is a fragmentary illustration of an engine employing an ORC subsystem in which engine intake air is cooled by an air conditioning cycle

FIG. 15 is a simplified, stylized schematic illustration of a combined muffler, contaminant catalyst and ORC working fluid evaporator.

### MODE(S) FOR CARRYING OUT THE INVENTION

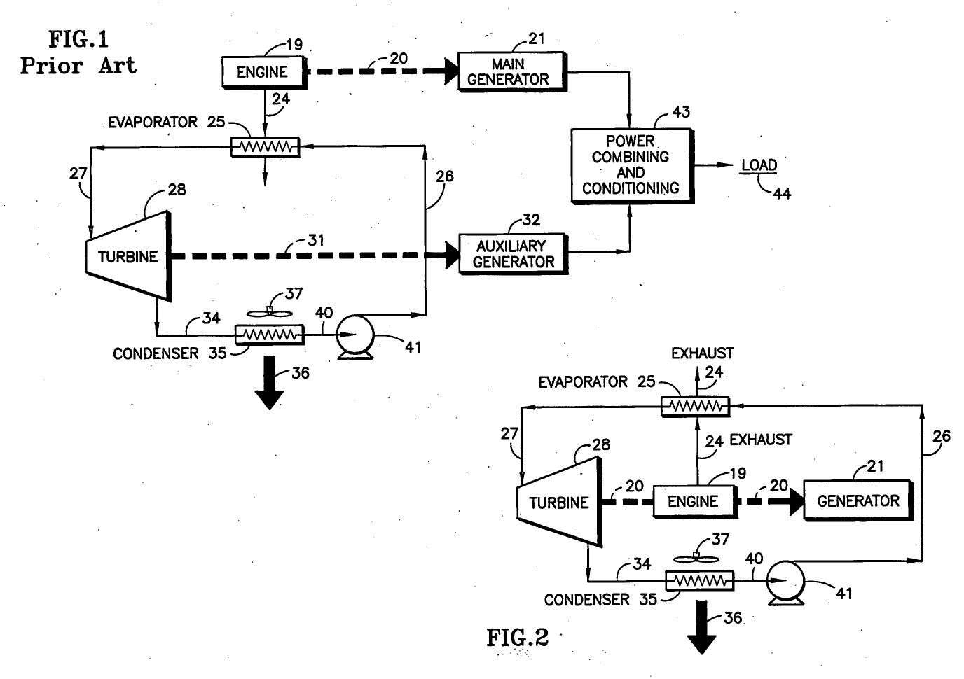

The simplest embodiment of the present invention, illustrated in FIG. 2, eliminates the need for an auxiliary generator 32 (FIG. 1) and the power combining processing associated therewith. This is achieved by causing the turbine (28) to be journaled on the same shaft 20 along with the engine 19 and a single generator 21. With the turbine rotor directly coupled to the engine shaft, the engine is started first, and actually drives the turbine as a load until the generated heat in the engine becomes sufficient to cause the ORC turbine 28 to contribute torque to the shaft 20.

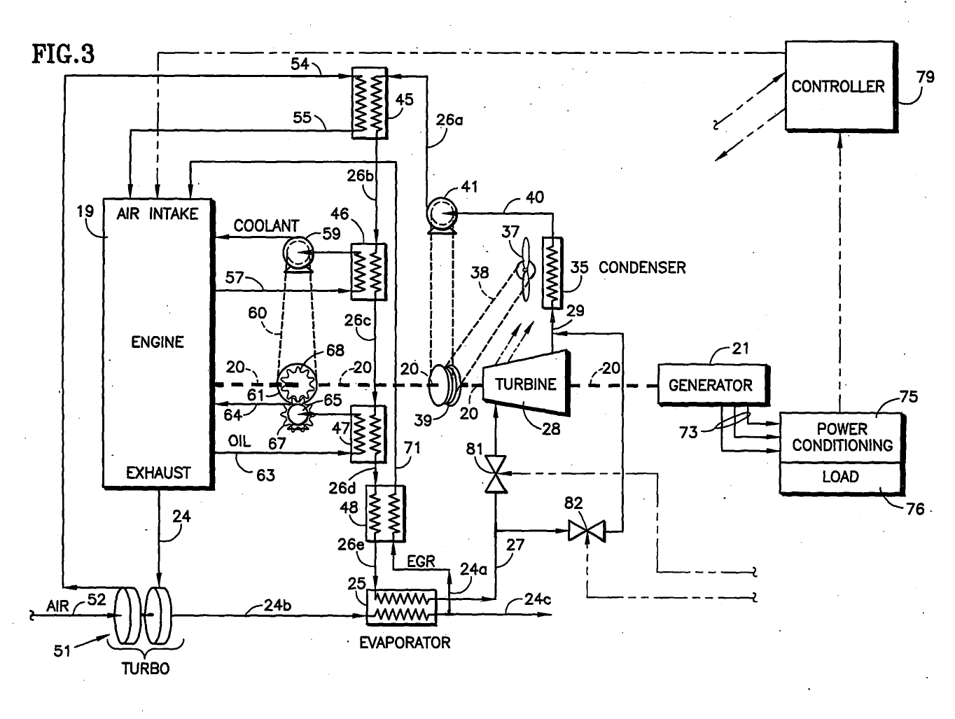

A simplified illustrative representation of a reciprocating engine with an organic Rankine cycle subsystem utilizing substantially all of the waste engine heat is shown in FIG. 3. Therein, instead of utilizing only exhaust heat in an evaporator, there are a plurality of preheaters 45-48, each consisting of a heat exchanger with the ORC fluid being warmed to increasing temperatures by engine waste heat.

The exhaust in exhaust pipe 24 is fed to drive a turbocharger 51 that compresses ambient air in an inlet 52, and provides compressed air in a conduit 54 to the preheater 45. The compression heat is substantially removed from the charge air, by heat exchange with the ORC fluid in a conduit 26a, providing much cooler compressed air in a conduit 55. The cooler intake air provided in the conduit 55, being more dense, causes the engine efficiency to increase by several percent.

The ORC fluid leaving the preheater 45 in a conduit 26b is applied to the preheater 46 which receives in a conduit 57 coolant from the engine cooling jacket and/or labyrinth as the case may be. The coolant, passing through the heat exchanger 46 is driven by a pump 59 which may be coupled mechanically by a belt 60 to a pulley 61 driven by the combined engine/turbine shaft 20.

The ORC fluid then flows through a conduit 26c to the preheater 47, which also receives engine oil over a conduit 63. The oil is returned to the engine over a conduit 64 by means of a pump 65 which is indicated as being gear driven by means of a pair of intermeshed gears 67, 68.

The heat exchangers 46, 47 which will accomplish the preheating just described can be much smaller and therefore cheaper than the radiator (which is liquid-to-air) and the oil cooler (which is either oil to ambient air or oil to engine coolant). This is because there is forced liquid convection heat transfer on both sides of the heat exchanger, and the forced convection is provided by the ORC fluid pump 41, the coolant pump 59 and the oil pump 65, rather than using energy and space-consuming fans which would be required on a typical radiator or an ambient cooled oil cooler.

The ORC fluid then flows over a conduit 26d to the heat exchanger 48 where it is heated by the exhaust gas recycle (EGR) flow in an EGR conduit 24a. The cooled EGR gas is conducted to the air intake by a conduit 71.

The ORC fluid then flows through a conduit 26e to the evaporator 25, which comprises a bi-phase heat exchanger that receives exhaust from the turbo over a pipe 24b and applies it to the exhaust pipe 24c.

The ORC fluid, passing through the preheaters 45-48 and the evaporator 25 receives the highest possible enthalpy, while providing the cooling functions for the engine without use of fans. The ORC fluid flows through the conduit 27 to drive the turbine 28, the spent ORC fluid passing through the conduit 29 to the condenser 35. The fan 37 on the condenser is driven through a belt 38 by a pulley 39 on the common shaft 20. The ORC fluid then flows through conduit 40 and is driven by pump 41 to the preheater 45.

The generator 21 may be connected by a suitable electrical bus 73 to power conditioning circuitry 75 which in turn is interconnected with an electrical load 76, which may be a grid. A controller 79 may respond to load conditions, conditions in the turbine such as pressure ratio, speed and temperature, and engine conditions, so as to control various factors in the system, including turbine pressure relief, such as by means of bypass valves 81, 82.

Though not illustrated in FIG. 3 for clarity, an oil pump which pressurizes ORC turbine lubricating oil is typically operated by an electric motor in systems known to the prior art. However, for a greater assurance of turbine operability, the turbine oil pump may be coupled to the shaft 20 (or the shaft 20a of the turbine, FIG. 4), in the same fashion as described with respect to the oil pump 65 (FIG. 3). Alternatively, engine oil leaving the heat exchanger 47 may be passed through the turbine 28 prior to return through the conduit 64 to the engine, if deemed suitable in any implementation of the present invention.

Although shown with four preheaters in FIG. 3, the invention may be implemented utilizing selected ones of the preheaters 45-48 in order to achieve the lowest cost per unit power generated by the combined engine/ORC system through minimizing heat exchanger size to reduce cost while minimizing engine intake temperature and maximizing ORG fluid temperature to improve both the engine and ORC cycle efficiencies.

In a typical organic Rankine cycle system used with an internal combustion engine, such as for driving a generator, the main pump of the ORC is typically driven by an electric motor powered from the grid that the generator provides power to. Similarly, the fan providing cooling air to the condenser is also typically driven by an electric motor powered by the grid. In the event of failure of any ORC components, system control or grid power, the ORC system components should be protected, and cooling of the reciprocating engine must be assured.

Because most of the power being provided by the system is provided by the engine, rather than the ORC subsystem, the engine system should be able to operate in the event of an ORC subsystem failure, because it will supply substantial power, although with less efficiency. FIG. 4 is a fractional illustration of a modification of the system of FIG. 3 in which the turbine is not journaled on the same shaft 20 with the engine, but instead is journaled on a shaft 20a which is connected to the engine by means of a free-wheeling clutch 80. The engine can turn without turning the turbine due to the free wheeling clutch. In normal operation, the engine is started and as the heat builds up sufficiently, the turbine will produce torque. The turbine speed will continuously increase as the heat input from the engine increases until the speed of the turbine merely turning one-half of the clutch, will easily reach the speed of the engine. At that time, the turbine will supply torque through the free-wheeling clutch to the shaft 20.

In the event the ORC subsystem should fail, the free-wheeling clutch will isolate the shaft 20a from the shaft 20. The turbine is normally fed the heated ORC fluid through the valve 81, the valve 82 being blocked. But when there is an ORC subsystem failure, in order to prevent overheating of the engine, the bypass valve 82 is opened and the valve 81 is closed, so that the engine heat is passed from the conduit 27 through the conduit 29 to the condenser 35. Provisions can be made for additional fans or an increased fan speed at the condenser to remove additional heat from the ORC fluid, to compensate for the heat no longer being converted to work by the turbine.

The valves 81, 82 may be computer controlled, in response to characteristics of the system, such as engine temperature, turbine pressure ratio, and the like. On the other hand, the valves 81, 82 may simply comprise passively sprung vapor valves.

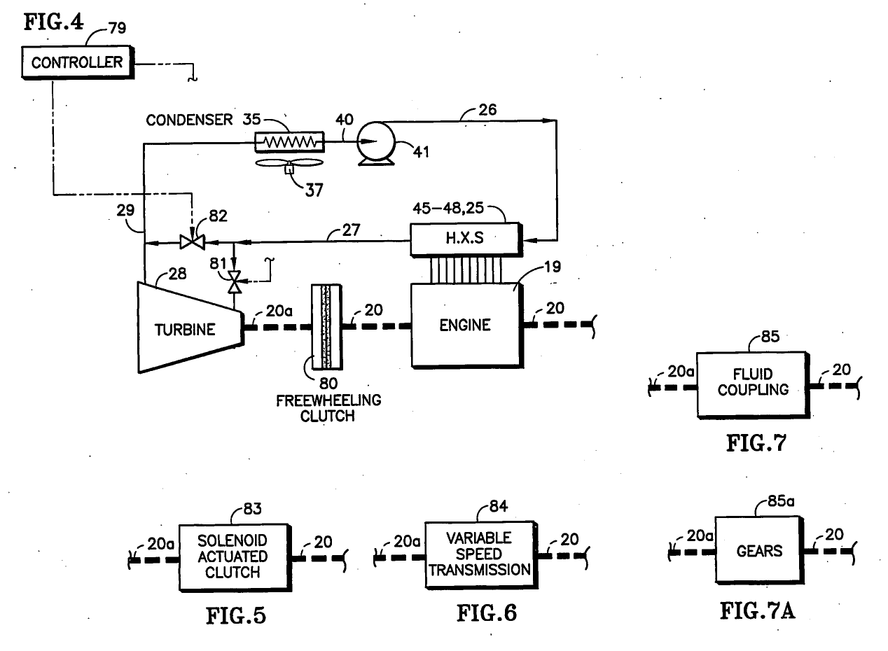

Various couplings may be used between the engine 19 and the turbine 28. For instance, they may be journaled on a common shaft 20 as described with respect to FIGS. 2 and 3 hereinbefore. On the other hand, instead of a free-wheeling clutch 80, a solenoid actuated clutch 83 may be used as illustrated in FIG. 5. Alternatively, a variable speed transmission 84, as illustrated in FIG. 6 may be-utilized. A fluid coupling 85 may be utilized as illustrated in FIG. 7.

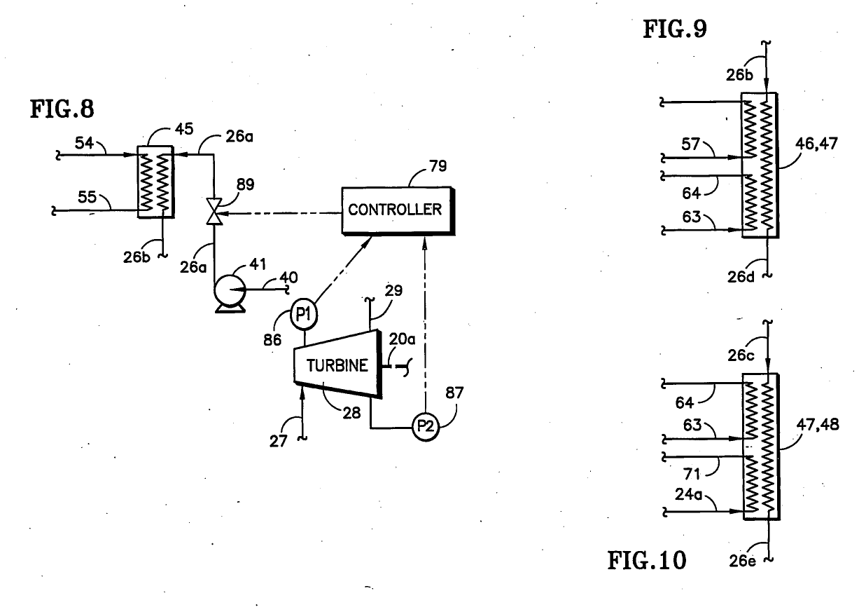

The bypass valve 82 (FIGS. 3 and 4) may be used to relieve flow through the turbine so as to avoid exceeding maximum turbine pressure ratio, pressure drop in ORC working fluid across the turbine. Alternatively, the relationship between turbine speed and pressure ratio can be altered by altering the rate of mass flow through the ORC subsystem. This is illustrated in FIG. 8 wherein the controller 79 monitors an indication of the turbine inlet pressure, P1, from a pressure sensor 86 as well as the turbine outlet pressure, P2, as indicated by a pressure sensor 87. If the pressure drop becomes too high, the controller can reduce the flow of the ORC fluid by causing a flow restricting valve 89, disposed in conduit 26a, to reduce the mass flow of the ORC fluid. Similarly, if the turbine is not approaching maximum pressure, the controller may command an increase in flow through the flow restricting valve 89. This allows the ORC subsystem to decouple the speed of the turbine from the pressure drop thereacross, allowing maximum efficiency at a variety of loads.

An alternative to the control of mass flow by the valve 89 is use of a variable speed transmission 84 referred to with respect to FIG. 6 hereinbefore. In such a case, the speed of the turbine may be held essentially constant at a maximum efficiency speed, allowing the variable speed transmission to accommodate the difference between turbine speed and either engine speed or load speed, depending on how the mechanical coupling is established.

For economy, a variable speed transmission may not seem suitable. In such a case, the coupling ratio of engine speed to turbine speed may be selected to be optimum at the maximum pressure drop across the turbine at the full load; this may result in less than optimum pressure ratios at reduced engine load. Alternatively, an intermediate pressure ratio could be chosen for optimization, and the pressure limiting bypass valve 82 or the mass flow controlling valve 89 utilized accordingly.

As illustrated in FIG. 9, to reduce space and cost, a multi-fluid heat exchanger 46, 47 may be utilized to bring together the engine coolant fluid from conduit 57, oil from the engine passing through conduits 63 and 64, and the ORC fluid conducted from the conduit 26b to the conduit 26d. Similarly, a multi-fluid heat exchanger 47, 48, as shown in FIG. 10, may bring together the engine oil circulating in conduits 63 and 64, the EGR flow passing from conduit 24a to conduit 71, and the ORC fluid flowing from conduit 26c to conduit 26e.

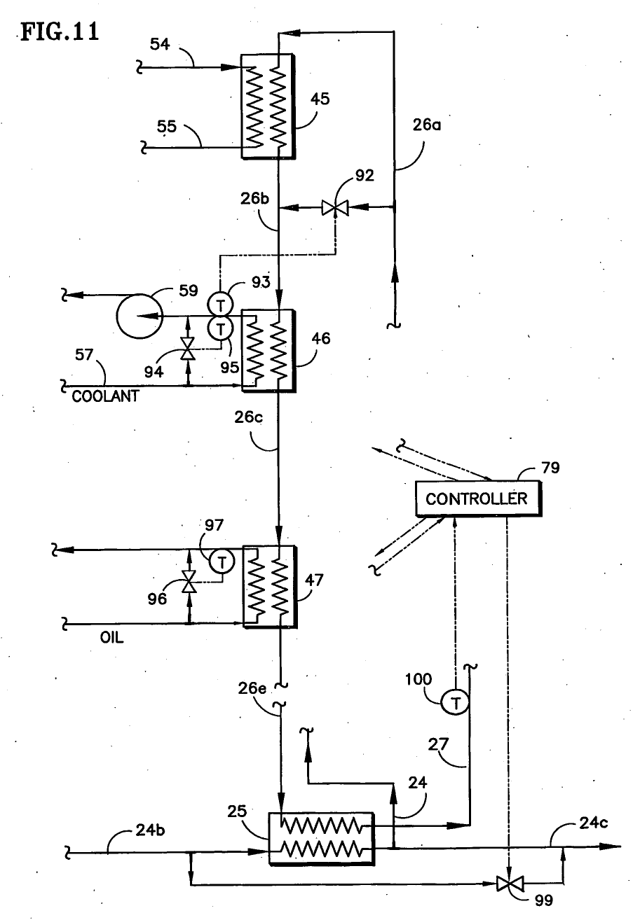

For maximum engine efficiency, it is necessary to provide the charge air at the coolest possible temperature. However, if the ORC working fluid is heated too much in the heat exchanger 45, then it is possible that either the engine coolant or the engine oil might become too hot. In order to provide maximum cooling of the charge air, the heat exchanger 45 may be made excessively large, and the amount of ORC working fluid passing therethrough bypassed as necessary to permit proper cooling of the coolant and engine oil, as illustrated in FIG. 11. A bypass valve 92 comprises a remotely sensed temperature controlled valve, the temperature being sensed at the coolant outlet of the heat exchanger 46. If the coolant temperature rises above some predetermined amount, such as on the order of 93° C. (200° F.), the remotely sensed temperature-controlled valve 92 will open proportionately to bypass some of the ORC working fluid around the heat exchanger 45, thus enabling the ORC working fluid to cool the engine coolant or oil more effectively in the heat exchangers 46, 47. The valve 92 may alternatively be placed across the conduits 54, 55 to bypass the intake air around the heat exchanger 45.

Similarly, if the engine coolant falls below a desirable temperature, such as on the order of 70° C. (160° F.), a remotely sensed temperature-controlled valve 94 will open proportionately to bypass some of the coolant around the heat exchanger 46 so that the coolant can maintain the minimal desired temperature. In the same way, a remotely sensed temperature-controlled valve 96 will bypass engine oil if necessary to maintain the minimum temperature, such as about 43° C. (110° F.). Alternatively, the valves 94, 96 may be placed between conduits 26b and 26c or 26c and 26d, respectively, to bypass ORC working fluid around the respective heat exchanger 46, 47.

In addition, FIG. 11 illustrates that a desired superheat temperature of the ORC working fluid can be maintained in the conduit 27 regardless of fluctuations that occur in the heat exchangers 45-48 due to engine variations, by regulating a bypass valve 99 in a manner determined by the controller 79, in response to a temperature sensor 100, responsive to the temperature of the superheated ORC working fluid in the conduit 27. The valve 99 may be controlled by the controller 79, or it may be a pressure sensing bulb controlling a valve in proportion to ORC working fluid pressure, such as a TXV type valve.

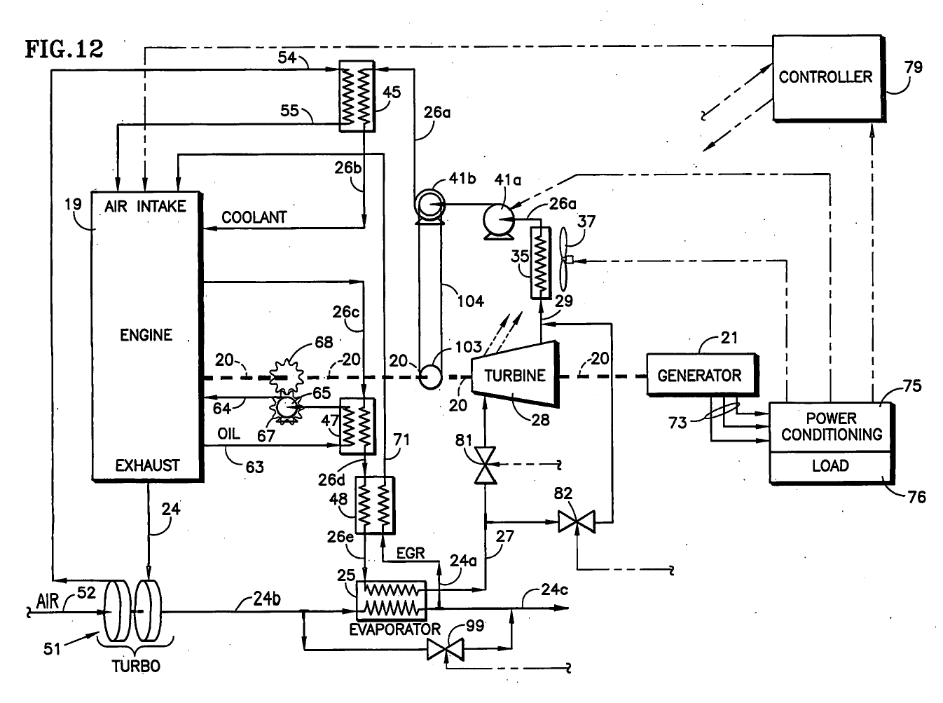

FIG. 12 illustrates several other variations which may be employed in any given implementation of the invention. One innovation is the direct application of ORC fluid within the conduit 26b to the engine coolant passages, such as the coolant jacket and/or labyrinth of the engine, the heated coolant being applied to the conduit 26c. This provides a maximal transfer of engine heat directly to the ORC fluid. However, in the event that the ORC subsystem becomes inoperative, so the turbine is not converting heat into torque on the shaft, provisions have to be made to ensure that the engine will remain cool. In the event that the main ORC fluid pump 41a is powered by electricity, particularly if powered by the grid, there is a danger that it may fail. To ensure coolant to the engine, a backup pump 41b is provided, which is driven by the shaft 20, such as by means of a pulley 103 driving a belt 104. The pump 41b is sized to provide a reduced flow at a pressure that will result in saturated ORC working fluid vapor at the exit of the engine when the engine is operating at its design point.

Less than half of the ORC heat load comes from the engine cooling jacket and/or labyrinth; the majority of the heat coming from the engine exhaust system. In order to ensure removal of engine heat, the evaporator is bypassed by the valve 99, as described hereinbefore.

In addition, the turbine must be bypassed by closing the valve 81 and opening the valve 82 to divert the ORC working fluid around the turbine. If these valves are not controlled by the computer, they may comprise passive spring vapor valves. When the ORC working fluid is used as the coolant for the engine, the condenser 35 may be provided with extra fans, or the fan 37 may preferably be driven by the shaft 20, as described with respect to FIG. 3 hereinbefore. If the fan 37 is to be driven by electricity, it may be preferable to power the fan with electricity provided by the generator 21, through the power conditioning apparatus, as shown in FIG. 12, rather than relying on grid electricity. Therefore, when the engine is running, the fan 37 will have power and will be able to remove engine heat from the ORC working fluid.

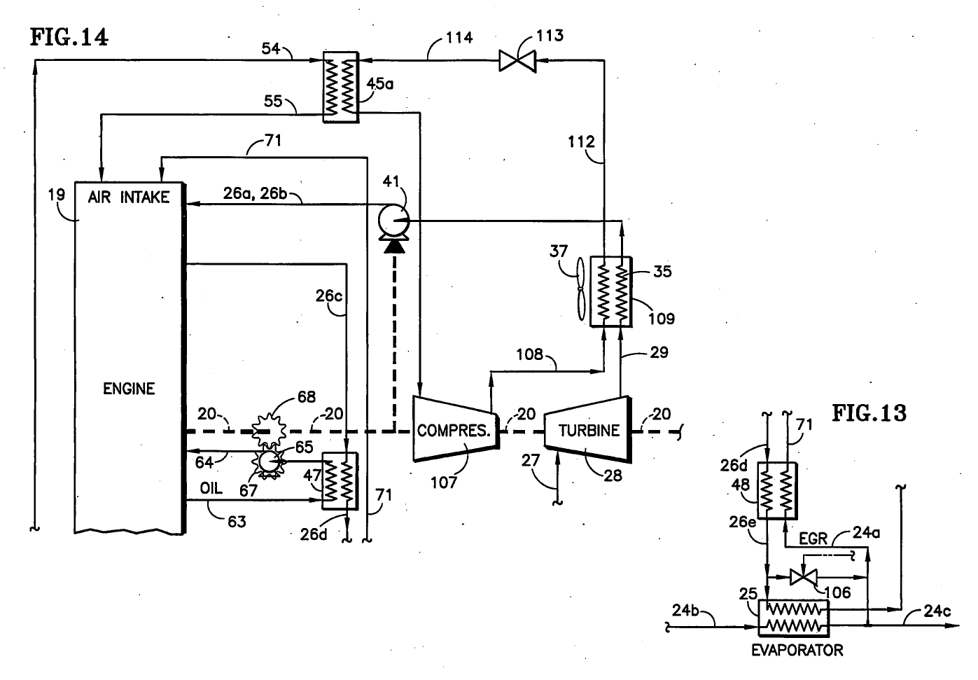

As an alternative to bypassing the exhaust around the evaporator from the pipe 24b to the pipe 24c, the ORC working fluid might be bypassed around the evaporator, as shown in FIG. 13, by means of a valve 106 which may be controlled by the controller 79 or may simply be a passive valve that opens at a high temperature, which may be on the order of 120° C. (250° F.). However, in such a case, the evaporator must be designed to reach the temperature of the exhaust without impairing the integrity of the evaporator.

Referring to FIG. 14, refrigeration cycles can provide large cooling capacity with relatively little power input, and are therefore highly efficient. In order to achieve maximum efficiency from the engine 19, the compression heat, and more, can be removed from the engine intake air by means of a heat exchange with refrigerant, such as R134a, cooled even below ambient air temperature.

A compressor 107 coupled to the shaft 20 provides compressed refrigerant over a conduit 108 to a condenser 109. The cooled liquid refrigerant is then applied over a conduit 112 through an expansion valve 113 and a conduit 114 to the inlet of the evaporator, which comprises the heat exchanger 45a, where it chills the engine's inlet air. This embodiment may be used with engines that do not use a turbocompressor at the air intake, as well as those that do. As seen in FIG. 14, the compressor 107 is coupled to the same shaft 20 as the turbine and the engine. This aspect of the invention achieves lower air intake temperatures than cooling the intake air could possibly be achieved with engine coolant, and avoids the necessity of a costly and parasitic fan which would be required for cooling the intake air with ambient air.

As illustrated in FIG. 14, the invention may be practiced with a combined condenser 35, 109 so that the waste heat of the refrigeration cycle may be used to preheat the ORC working fluid to some extent.

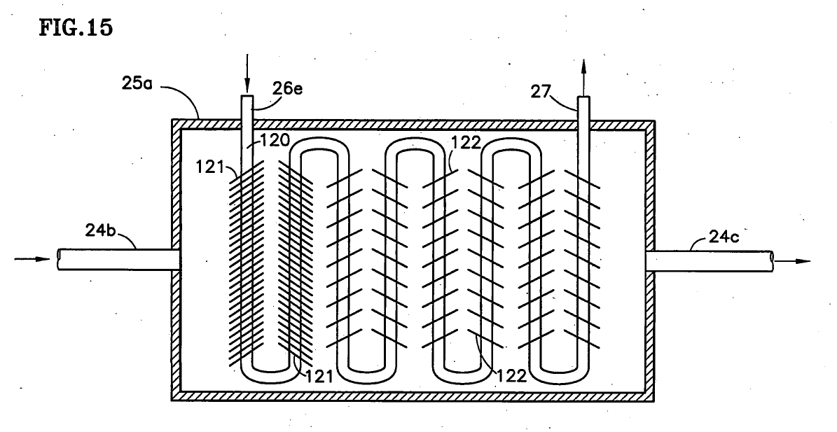

A large percentage of the engine's waste heat is carried in the exhaust stream, so successful bottoming cycles will generally incorporate a heat exchanger (such as the evaporator) on the engine exhaust. For further efficiency, one aspect of this invention consists of sharing the functions of a reciprocating engine exhaust muffler and catalyst for NOx and/or particulate removal, with that of a superheating heat exchanger for an organic Rankine bottoming cycle. Referring to FIG. 15, a combined muffler and evaporator 25a causes the ORC working fluid to run inside serpentine channels 120 that are surrounded by a large surface area of fins 121, 12. The fins are relatively closely spaced, with reversal of flow angle in each row of the channel 120 so as to diff-use and suppress the pressure pulses of the exhaust, thereby reducing the exhaust noise and possibly obviating the need for a separate exhaust muffler. In addition, the fins 121 may be covered with an appropriate catalyst material so as to reduce carbon monoxide and NOx emissions. Such catalysts typically operate at high temperature, and are isolated from ambient in the vaporizer 25a. By controlling the temperature of the ORC working fluid at the inlet of the combined muffler/evaporator 25a, (using bypass techniques similar to those described hereinbefore), the temperature of the catalyst may be controlled while utilizing all rejected heat, rather than losing the heat to the environment. Thus, another efficiency can be achieved by means of the ORC subsystem as a bottoming cycle for an internal combustion engine.

1. Apparatus, comprising:
a load (21);
an internal combustion engine (19) having a shaft (20) through which it delivers torque to the load, said engine having an air inlet receiving air from a source (51), said engine having exhaust (24) passing through a heat exchanger (25);
an organic Rankine cycle subsystem including a turbine (28) having a shaft (20, 20a) coupled to said engine shaft and having an organic Rankine cycle working fluid that is vaporized in said heat exchanger;
characterized by:
said organic Rankine cycle working fluid being preheated (45-48), before vaporization, by heat extracted from one or more engine fluids of said engine, to thereby cool the engine, said heat exchanger comprising an evaporator (25) for heating the organic Rankine cycle working fluid with engine exhaust (24), said evaporator having a serpentine organic Rankine cycle fluid flow conduit (120) with exhaust pressure pulse reducing fins (121, 122) disposed on said conduit;
an air conditioning subcycle system having a coolant compressor (107) mechanically coupled to said shaft (20), a coolant condenser (109) receiving coolant flow from said compressor, an expansion valve (113) passing coolant flow from said coolant condenser, and an evaporator (45a) in fluid communication between the expansion valve and the compressor, said evaporator comprising a heat exchanger providing thermal communication between said coolant flow and air flowing from said source to said air inlet;
turbine bypass valving (81, 82) selectively operable to bypass the organic Rankine cycle working fluid around the turbine; and
means (81, 82, 84, 89) for controlling organic Rankine cycle working fluid pressure drop across the turbine.

2-3. (canceled)

4. Apparatus comprising:
an exhaust heat exchanger (25);
an internal combustion engine (19) configured to deliver torque to a shaft (20), said engine configured to provide exhaust (24) through said exhaust heat exchanger;
an organic Rankine cycle subsystem configured to have working fluid in fluid passageways (26, 27, 29, 40, 45-48) vaporized in said exhaust heat exchanger;
characterized by:
said exhaust heat exchanger (25) has a selectively operable bypass valve (99, 106) to maintain a predetermined superheated organic Rankine cycle vapor temperature.

5. Apparatus according to claim 4 further characterized by:
said bypass valve (99) is configured to bypass the engine exhaust (24) around said exhaust heat exchanger (25).

6. Apparatus according to claim 4 further characterized by:
said bypass valve (106) is configured to bypass the organic Rankine cycle fluid around said exhaust heat exchanger (25).

7. Apparatus according to claim 4 further characterized by:
a controller (79) responsive to organic Rankine cycle vapor temperature (100) for selectively operating said bypass valve (99).

8. Apparatus according to claim 4 further characterized by:
said bypass valve (99, 106) is a passive, thermostatic valve.

9. Apparatus comprising:
an exhaust heat exchanger (25);
an internal combustion engine (19) configured to deliver torque to a shaft (20), said engine configured to provide exhaust (24) through said exhaust heat exchanger;
an organic Rankine cycle subsystem configured to have working fluid in fluid passageways (26-27, 29, 40, 45-48) vaporized in said exhaust heat exchanger;
characterized by:
said fluid flow passageways configured to transfer (46, 47) engine heat from at least one engine fluid passageway to said organic Rankine cycle fluid in at least one heat exchanger (46, 47) having at least one selectively operable bypass valve (94, 96).

10. (canceled)

11. Apparatus according to claim 9 further characterized by:
said fluid flow passageways (26b, 26c) including a coolant heat exchanger (46) thermally coupled with the engine coolant passageways;
said coolant heat exchanger (46) having at least one selectively operable bypass valve (94).

12. Apparatus according to claim 11 further characterized by:
said bypass valve (94) is configured to bypass the organic Rankine cycle fluid around the coolant heat exchanger (46).

13. Apparatus according to claim 11 further characterized by:
said bypass valve (94) is configured to bypass engine coolant around the coolant heat exchanger (46).

14. (canceled)

15. Apparatus according to claim 27 further characterized by:
said fluid flow passageways configured to transfer (47) engine heat from engine oil passageways (63, 64, 65).

16. (canceled)

17. Apparatus according to claim 9 further characterized by:
said fluid flow passageways including an oil heat exchanger (47) thermally coupled with the engine oil; and
said oil heat exchanger (47) having at least one selectively operable bypass valve (96).

18. Apparatus according to claim 17 further characterized by:
said bypass valve (96) is configured to bypass the organic Rankine cycle fluid around the oil heat exchanger.

19. Apparatus according to claim 17 further characterized by:
said bypass valve (96) is configured to bypass engine oil around the oil heat exchanger.

20. Apparatus according to claim 4 further characterized by:
an oil pump (65) configured to circulate engine oil;
said turbine (28) has an oil lubricating system; and
said oil pump is configured to pressurize oil for said oil lubricating system.

21-22. (canceled)

23. Apparatus according to claim 9 further characterized by:
said fluid flow passageways (26b, 26d) are thermally coupled with engine coolant passageways (57) and engine oil passageways (63, 64) in respective individual coils of a single heat exchanger (46, 47).

24. (canceled)

25. Apparatus according to claim 27 further characterized by:
said fluid flow passageways (26c, 26d, 26e) are thermally coupled with an exhaust gas recycle flow passageway (24a, 71) and with an engine oil passageway (63, 64) by respective separate heat exchangers (48, 47).

26. Apparatus according to claim 27 further characterized by:
said fluid flow passageways (26c, 26e) are thermally coupled with an exhaust gas recycle flow passageway (24a, 71) and with an engine oil passageway (63, 64) by respective individual coils of a single heat exchanger (47, 48).

27. Apparatus comprising:
an exhaust heat exchanger (25);
an internal combustion engine (19) configured to deliver torque to a shaft (20), said engine configured to provide exhaust (24) through said exhaust heat exchanger;
an organic Rankine cycle subsystem configured to have working fluid in fluid passageways (26, 27, 29, 40, 45-48) vaporized in said exhaust heat exchanger;
characterized by:
said fluid flow passageways configured to transfer (48) engine heat from an engine exhaust gas recycle flow passageway (24a, 71).

28-29. (canceled)

30. Apparatus according to claim 9 further characterized by:
said fluid flow passageways (26a, 26b) including an engine inlet air heat exchanger (45) thermally coupled with the engine compressed intake air passageway (54, 55) and having a selectively operable bypass valve (92).

31. Apparatus according to claim 30 further characterized by:
said bypass valve (92) is configured to bypass the organic Rankine cycle fluid around the inlet air heat exchanger (45).

32. Apparatus according to claim 30 further characterized by:
said bypass valve (92) is configured to bypass the inlet air around the inlet air heat exchanger (45).

33. Apparatus according to claim 4 further characterized by:
said exhaust heat exchanger (25a) having a serpentine organic Rankine cycle fluid flow conduit (120) with exhaust pressure pulse reducing fins (121, 122) disposed on said conduit.

34. Apparatus according to claim 33 further characterized by:
said fins (121, 122) being oriented at an angle to each one row of the serpentine conduit which is opposite to an angle at which said fins are oriented to rows of the serpentine conduit adjacent to said each one row.

35. Apparatus according to claim 33 further characterized by:
at least a portion of the fins (121) being covered by a catalyst selected to aid in reducing at least one of oxides of nitrogen and particulates in the exhaust.

36. Apparatus comprising:
an exhaust heat exchanger (25);
an internal combustion engine (19) configured to deliver torque to a shaft (20), said engine configured to provide exhaust (24) through said exhaust heat exchanger;
an organic Rankine cycle subsystem configured to have working fluid in fluid passageways (26, 27, 29, 40, 45-48 vaporized in said exhaust heat exchanger;
characterized by:
turbine bypass valving (81, 82) selectively operable to bypass the organic Rankine cycle working fluid around the turbine.

37. Apparatus according to claim 36 further characterized by:
said valving (81, 82) is configured to bypass the turbine (28) in the event of organic Rankine cycle subsystem failure thereby to continue to cool the engine.

38. Apparatus according to claim 36 further characterized by:
said organic Rankine cycle subsystem includes a condenser (35) configured to provide a first amount of heat transfer during normal operation and to provide a second amount of heat transfer greater than said first amount in the event of organic Rankine cycle failure.

39. Apparatus according to claim 36 further characterized by:
a selectively operable exhaust heat exchanger bypass valve (99, 106).

40. Apparatus according to claim 39 further characterized by:
said exhaust heat exchanger bypass valve (99) is configured to bypass exhaust (24) around the exhaust beat exchanger (25).

41. Apparatus according to claim 39 further characterized by:
said exhaust heat exchanger bypass valve (106) is configured to bypass the organic Rankine cycle working fluid around the exhaust heat exchanger (25).

42. Apparatus according to claim 36 further characterized by:
said turbine bypass valving (81, 82) being selectively operable to control pressure drop across the turbine.

43. Apparatus, comprising:
an engine (19) configured to apply torque to a shaft (20), said engine having an air inlet configured to receive air from a source (54, 51);
characterized by:
an air conditioning subcycle system having a coolant compressor (107) mechanically coupled to said shaft, a coolant condenser (109) receiving coolant flow from said compressor, an expansion valve (113) having a fluid coupling to said coolant condenser, and an evaporator (45a) providing fluid coupling between the expansion valve and the compressor, said evaporator comprising a heat exchanger providing thermal coupling between said coolant flow and air flowing from said source to said air inlet.

44. Apparatus according to claim 43 farther characterized by:
an organic Rankine cycle subsystem including a turbine (28) having a shaft (20, 20a) coupled to said engine shaft (20) and configured to have organic Rankine cycle working fluid in fluid flow passageways (26, 27, 29, 40, 45-48) vaporized (25) by heat (24) generated by said engine, said organic Rankine cycle subsystem including an organic Rankine cycle fluid condenser (35) disposed adjacent to said coolant condenser (109) and configured to transfer heat from the coolant flow to the organic Rankine cycle working fluid.

45. Apparatus according to claim 43 further characterized by:
said source of inlet air comprising an engine inlet air compressor (51).

46. Apparatus characterized by:
means (81, 82, 84, 89) for controlling organic Rankine cycle working fluid pressure drop across the turbine, said means selected from (a) means (89) for controlling the mass flow of the organic Rankine cycle working fluid, and (b) a fixed transmission (85a) coupling the turbine (28) to the engine shaft (20), with said engine (19) configured to operate at a predetermined rotary speed, at a ratio to cause said turbine to operate at an optimum turbine rotary speed for a maximum allowable turbine pressure drop, and said bypass valve (82) configured to selectively bypass a portion of the organic Rankine cycle working fluid around the turbine to prevent the pressure drop across the turbine from exceeding the maximum allowable pressure drop.
